(19) United States
(12) Patent Application Publication
(10) Pub. No.: US 2015/0168634 A1
(43) Pub. Date: Jun. 18, 2015

(54) DISPLAY DEVICE AND BACKLIGHT MODULE THEREOF

(71) Applicants: Qisda (Suzhou) CO., Ltd., Suzhou (CN); Qisda Corporation, Gueishan (CN)

(72) Inventors: YI-CHIEH LU, Longtan Town (TW); YI-CHENG KUO, Guishan Township (TW)

(21) Appl. No.: 14/500,963

(22) Filed: Sep. 29, 2014

(30) Foreign Application Priority Data
Dec. 16, 2013 (TW) 102146470

(51) Int. Cl. F21V 8/00

(52) U.S. Cl. CPC G02B 6/0061; G02B 6/0068; G02B 6/0073; G02B 6/0055

(57) ABSTRACT

A display device includes a backlight module and a display panel. The backlight module includes a light guide plate, a light source, a reflecting sheet and a light transmissible member. The light source is disposed at a first side of the light guide plate and used for emitting a light into the light guide plate, wherein the light has a first color. The reflecting sheet is disposed at a second side of the light guide plate. The light transmissible member is disposed between the light guide plate and the reflecting sheet and has a second color, wherein the first color and the second color are complementary colors, such that white light is generated when the light guided by the light guide plate passes through the light transmissible member. The display panel is disposed above the light guide plate.

### BACKGROUND OF THE INVENTION

1. Field of the Invention

The present invention relates to a display device and a backlight module thereof, and more particularly, to a display device and a backlight module thereof which can effectively avoid light leakage.

2. Description of the Prior Art

Since the liquid display device has the advantages of thin thickness, lightweight, low power consumption, no radiation and being able to be manufactured by the semi-conductor technology, the liquid display device is broadly applied in many kinds of electronic devices, such as the lap top computer, the mobile phone, the digital camera and the personal digital assistant (PDA), etc. The liquid display device displays a screen by the backlight module emitting light to the display module. Generally speaking, the backlight module normally includes a light source, a light guide plate, a reflecting sheet and an optical film set, wherein the light source is disposed at one side of the light guide plate, the reflecting sheet is disposed at another side, and the optical film set is disposed at a light output side of the light guide plate. The light source provides light, the light guide plate guides the light toward the display panel, the reflecting sheet reflects the light so as to increase the light usage rate at the light output side of the light guide plate, and the optical film set improves the optical characteristics of the light. The optical films included in the optical film set may include, for example, the prism film and the diffusion film. Up to now, the reflecting sheet is generally attached to the side of the light guide plate by the transparent double-sided adhesive tape. When the light emitted by the light source is not white light, such as blue light, the light leakage at the side of the light guide plate is visually obvious and has negative influence on the user.

### SUMMARY OF THE INVENTION

One of the purposes of this invention is to provide a display device and a backlight module thereof which can effectively decrease the influence of light leakage so that aforementioned problems can be resolved.

According to one embodiment, a display device is provided in this invention. The display device comprises a backlight module and a display panel. The backlight module comprises a light guide plate, a light source, a reflecting sheet and a light transmissible member. The light source is disposed at a first side of the light guide plate for emitting alight into the light guide plate. The light has a first color. The reflecting sheet is disposed at a second side of the light guide plate. The light transmissible member is disposed between the light guide plate and the reflecting sheet, and has a second color. The first color and the second color are complementary colors such that white light is generated when the light guided by the light guide plate passes through the light transmissible member. The display panel is disposed above the light guide plate.

According to another embodiment, a backlight module is provided in the invention. The backlight module comprises a light guide plate, a light source, a reflecting sheet and a light transmissible member. The light source is disposed at a first side of the light guide plate for emitting a light into the light guide plate. The light has a first color. The reflecting sheet is disposed at a second side of the light guide plate. The light transmissible member is disposed between the light guide plate and the reflecting sheet, and has a second color. The first color and the second color are complementary colors such that white light is generated when the light guided by the light guide plate passes through the light transmissible member.

In conclusion, in this invention the light transmissible member is disposed between the light guide plate and the reflecting sheet, and the color of the light transmissible member and that of the light emitted by the light source are complementary colors. By this structure, the light emitted by the light source is first guided by the light guide plate, and then passes through the light transmissible member to generate white light. In this way, compared with light leakage of non-white light, that of white light, if any, which occurs at the light output side of the light guide plate is visually less obvious and the negative influence of light leakage on human eyes can therefore be decreased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustrative diagram of a display device according to an embodiment of the present invention.

FIG. 2 is a top view of the light guide plate, the light source, the reflecting sheet and the light transmissible member shown in FIG. 1.

### DETAILED DESCRIPTION

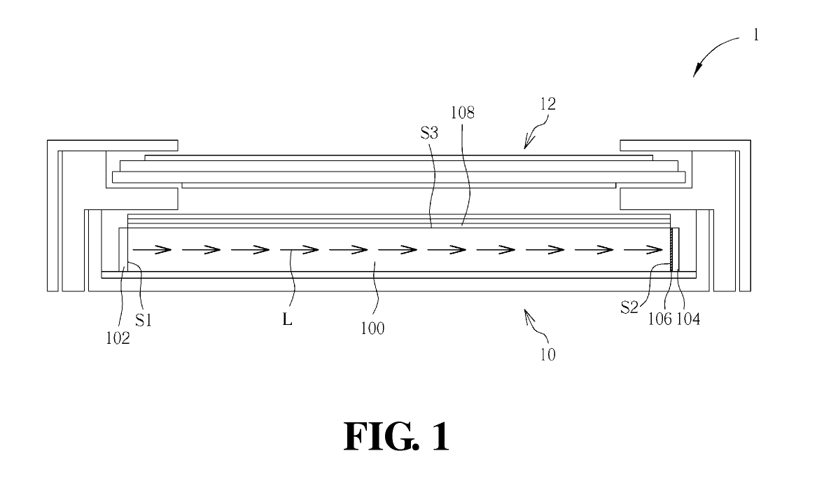

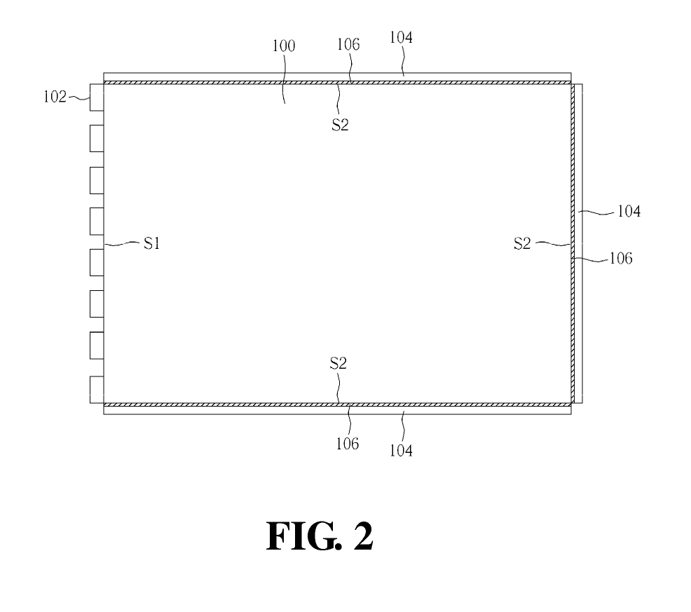

Please refer to FIG. 1 and FIG. 2. FIG. 1 is an illustrative diagram of a display device 1 according to an embodiment of the present invention. FIG. 2 is a top view of a light guide plate 100, a light source 102, a reflecting sheet 104 and a light transmissible member 106, which are also shown in FIG. 1 in different viewing perspective. As shown in FIG. 1, the display device 1 comprises a back light module 10 and a display panel 12. In the current embodiment, the display device 1 is a liquid display device, and the display panel 12 is a liquid display panel, but the invention is not so limited.

The back light module 10 comprises the light guide plate 100, the light source 102, the reflecting sheet 104, the light transmissible member 106 and a Quantum Dot Enhancement Film (QDEF) 108. The display panel 12 is disposed above the light guide plate 100. The light source 102 is disposed at a first side S1 of the light guide plate 100 for emitting a light L into the light guide plate 100. The light L has a first color. In this embodiment, the light source 102 is a LED, but is not so limited. The reflecting sheet 104 is disposed at a second side S2 of the light guide plate 100. In this embodiment, the first side S1 and the second side S2 are adjacent to or opposite to each other. As shown in FIG. 2, the one side that is adjacent to or opposite to the first side S1 can be defined as being the (aforementioned) second side S2. In other words, when the light source 102 is disposed at one side of the light guide plate 100, the reflecting sheet 104 can be disposed at one or more of the remaining three sides of the light guide plate 100, respectively.

In practical application, a dot pattern or other interference structure may be formed on the light guide plate 100, such that after the light source 102 emits the light L into the light guide plate 100, the light L can be diffused and directed toward the display panel 12. The reflecting sheet 104 reflects at least part of the stray light so as to increase the light output efficiency. Moreover, an optical film set is normally disposed at the light output side of the light guide plate 100 to improve the optical characteristics of the light. Depending on the practical application, the optical films included in the optical film set may include, for example, the prism film and the diffusion film, but is not so limited.

The light transmissible member 106 is disposed between the light guide plate 100 and the reflecting sheet 104, and has a second color. The first color of the light L and the second color of the light transmissible member 106 are complementary colors. For example, when the first color is blue, the second color is yellow; when the first color is yellow, the second color is blue; when the first color is red, the second color is cyan; when the first color is green, the second color is magenta; and so on. In this embodiment, the light transmissible member 106 is a double-sided tape with the second color for sticking the reflecting sheet 104 on the second side S2 of the light guide plate 100. In another embodiment, the light transmissible member 106 is made of a transparent gum and flourescence powders, and the flourescence powders have the second color. In another embodiment, the light transmissible member 106 is a fluorescence sheet.

The Quantum Dot Enhancement Film 108 is disposed at a light output side S3 of the light guide plate 100. In the current embodiment, the Quantum Dot Enhancement Film 108 cooperates with the blue light source to enhance the color rendering property and the color gamut of the light source. Thus, in the display device 1 with the Quantum Dot Enhancement Film 108, the light source 102, such as a blue light LED, emits blue light. It means that the aforementioned first color is blue and the aforementioned second color is yellow. The Quantum Dot Enhancement Film 108 includes two kinds of flourescence powders with different sizes. The blue light radiates the two kinds of flourescence powders to generate the red light and the green light. With the blue light emitted by the light source 102 passing through the Quantum Dot Enhancement Film 108, the generated red light, green light and the emitted blue light are mixed together to be the white light. Please note that in the display device 1, if no Quantum Dot Enhancement Film 108 is disposed therein, the light source 102 can emit light with or having blue or other color.

When the light source 102 emits the light L into the light guide plate 100, the light guide plate 100 diffuses and guides the light L toward the display panel 12. Besides, since the first color of the light L and the second color of the light transmissible member 106 are complementary colors, white light is generated when the light L guided by the light guide plate 100 passes through the light transmissible member 106. The light leakage of the blue light at the light output side S3 of the light guide plate 100 can therefore be avoided.

In conclusion, in the present invention, a light transmissible member is disposed between the light guide plate and the reflecting sheet of the display device, and the color of the light transmissible member and that of the light emitted by the light source are complementary colors. By this (backlight module) structure, when the light emitted by the light source passes through the light transmissible member, white light is generated. Compared with light leakage of non-white light, that of white light, if any, which occurs at the light output side of the light guide plate is visually less obvious and the negative influence of light leakage on human eyes can therefore be decreased.

Those skilled in the art will readily observe that numerous modifications and alterations of the device and method may be made while retaining the teachings of the invention.

What is claimed is:

1. A display device comprising:
a backlight module comprising:
a light guide plate;
a light source, disposed at a first side of the light guide plate for emitting a light into the light guide plate, wherein the light has a first color;
a reflecting sheet, disposed at a second side of the light guide plate; and
a light transmissible member, disposed between the light guide plate and the reflecting sheet and having a second color, wherein the first color of the light emitted by the light source and the second color of the light transmissible member are complementary colors, such that a white light is generated when the light guided by the light guide plate passes through the light transmissible member; and
a display panel, disposed above the light guide plate.

2. The display device of claim 1, wherein the light transmissible member is a double-sided tape.

3. The display device of claim 1, wherein the light transmissible member is made of a transparent gum and flourescence powders, and the flourescence powders have the second color.

4. The display device of claim 1, wherein the light transmissible member is a flourescence sheet.

5. The display device of claim 1, wherein the backlight module further comprises a Quantum Dot Enhancement Film disposed at a light output side of the light guide plate, the first color is blue and the second color is yellow.

6. The display device of claim 1, wherein the first side and the second side are adjacent to or opposite to each other.

7. A backlight module comprising:
a light guide plate;
a light source, disposed at a first side of the light guide plate for emitting a light into the light guide plate, wherein the light has a first color;
a reflecting sheet, disposed at a second side of the light guide plate; and
a light transmissible member, disposed between the light guide plate and the reflecting sheet and having a second color, wherein the first color of the light emitted by the light source and the second color of the light transmissible member are complementary colors, such that a white light is generated when the light guided by the light guide plate passes through the light transmissible member.

8. The backlight module of claim 7, wherein the light transmissible member is a double-sided tape.

9. The backlight module of claim 7, wherein the light transmissible member is made of a transparent gum and flourescence powders, and the flourescence powders have the second color.

10. The backlight module of claim 7, wherein the light transmissible member is a flourescence sheet.

11. The backlight module of claim 7, wherein the backlight module further comprises a Quantum Dot Enhancement Film disposed at alight output side of the light guide plate, the first color is blue and the second color is yellow.

12. The backlight module of claim 7, wherein the first side and the second side are adjacent to or opposite to each other.
